(19) United States
(12) Patent Application Publication
(10) Pub. No.: US 2008/0298273 A1
(43) Pub. Date: Dec. 4, 2008

(54) Method For Establishing a Communication Relationship in at Least One Communication Network

(76) Inventors: Friedrich Armbruster, Munchen (DE); Stephan Binde, Balerbrunn (DE); Chlodwig Neuhausler, Worthsee (DE); Christelle Sippel, Regensburg (DE)

Correspondence Address: BELL, BOYD & LLOYD, LLP, P.O. BOX 1135, CHICAGO, IL, 60690, US

(21) Appl. No.: 11/884,288

(22) PCT Filed: Jan. 23, 2006
(86) PCT No.: PCT/EP2006/050372

§ 371 Date: Mar. 26, 2008

(30) Foreign Application Priority Data
Feb. 15, 2005 (DE) 10 2005 006 889.8

(51) Int. Cl. H04L 12/28

(52) U.S. Cl. 370/254

(57) ABSTRACT

The invention relates to a method for establishing a communication link. According to said method, to establish said link, a communications unit transmits at least one message that initiates the establishment of the communications link in at least one communications network and at least one corresponding confirmation is transmitted with the aid of a broadcast transmission method in the direction of the initiating communications unit. The information that represents the initiating communications unit is stored in the communications network or networks. The confirmation(s) that has or have been transmitted with the aid of the broadcast transmission method is detected and target information that is contained in said confirmation is compared to the stored information. If the compared information agrees at least partially, the confirmation(s) is or are routed to the initiating communication unit represented by the communication unit.

In present-day communication networks, especially user access networks—referred to also simply as access networks—a plurality of users or communication devices allocated thereto are connected via multiplexer devices—referred to also as DSLAMs, meaning Digital Subscriber Line Access Multiplexers—to a superordinate communication network—referred to also as a backbone. The function of said multiplexer devices is to forward information from all users to the backbone network and to make information from the backbone network available directly to the individual users. To obviate unnecessarily over-loading the respective data-transmission paths' capacity and hence blocking of the communication device, the multiplexer device is designed such that all information requiring to be conveyed will be forwarded in the upstream direction, which is to say from the individual communication devices in the direction of the superordinate communication network, but only information addressed directly to the individual users will be forwarded in the downstream direction, which is to say from the superordinate network in the direction of the individual communication devices. That means that broadcast information sent within the superordinate communication network will not be conveyed from the respective multiplexer device to the respectively connected users.

If an access network of said type consists of, for instance, 4,096 users which, for example, send a resource request to the superordinate communication network at the same instant at a data rate of x bit/s, then there will be a transmission load of 4,096 * x bit/s in the upstream direction. If the superordinate communication network conveys a reply to each user by means of an appropriate, corresponding broadcast message at the same rate of x bit/s, then there will be, for example, a transmission load in the downstream direction of 4,096 * 4,096 * x bit/s. That will very soon result in multiplexer overloading.

The DHCP protocol (RFC 2131) is in present-day user access networks a typical application for assigning users, inter alia, an address embodied according to the Internet Protocol—which address is referred to below also as an IP address—, by means of which the respective users are authorized to exchange information over the internet within the scope of a communication relationship. IP addresses are within the scope of the DHCP protocol kept in a pool DHCP server and assigned only when required to a user establishing a communication relationship. As it is relatively unlikely that all users will be active simultaneously (particularly within the scope of an online service), the stock of IP addresses kept in the pool can be less than the total number of all possible users. Because the communication device (referred to also as a host) allocated to the respective user will not yet have assigned an IP address upon activation, which is to say when a communication relationship starts being established, a corresponding request or message will be sent by way of a DHCP discovery instruction by said communication device to active DHCP servers using a broadcast method. For identifying the requesting communication device the respective MAC address is inserted into the request messages sent. In response, a corresponding reply or acknowledgment (DHCP-OFFER) is sent by means of a broadcast in the direction of the requesting communication device by all active DHCP servers that have still freely allocatable IP addresses in the pool. The requesting communication device or host selects an offer (DHCP-REQUEST) and in turn makes it known to all DHCP servers by means of a broadcast. The selected DHCP server confirms by sending the IP address (DHCP-ACK) assigned for the communication device—all other DHCP servers will thereupon withdraw their offer.

Alongside the allocated IP address, further data relevant to network accessing, for example the subnetwork mask, the addresses of the domain name servers, and the standard gateway, can also be conveyed to the requesting communication device or host.

Within the scope of the DHCP protocol that is to assign an IP-address to the users or the communication devices allocated thereto there are two possible ways of sending the requesting communication device (DHCP client) replies or acknowledgments of the DHCP server assigning the IP addresses: Firstly, the reply can be addressed directly to the respective user or communication device and, secondly, the reply can be sent back as a broadcast. Forwarding of the directly addressed acknowledgments is unproblematic in the former case. A reply addressed directly to a user (unicast) will be forwarded by the multiplexer device (DSLAM) directly to the respectively addressed, connected user so that said user will be authorized to access the network using the assigned IP address—meaning that a communication relationship can be established via the communication network.

A technical problem arises in the latter case in that the messages sent within the scope of a broadcast transmission method or broadcast cannot be forwarded by the multiplexer devices to all communication devices connected to a multiplexer device as there will otherwise be a risk of overloading. The broadcast messages arriving at a multiplexer device will in that case be rejected, meaning that the respective user will not be assigned an IP address. That instance involving the acknowledgments (DHCP replies) sent within the scope of a broadcast arises in particular when additional network elements are located in a communication network behind the multiplexer device, which is to say in the superordinate communication network directly following it, that do not have any information about or overview of the structure of the multiplexer network or user access network and so basically forward DHCP replies as a broadcast in order to insure that all users or communication devices located in the user access network will receive said replies or acknowledgments.

The above-described problem of the rejecting of DHCP replies conveyed within the scope of broadcasting has hitherto not arisen in the current communication network because communication relationships requiring to be established between communication devices and the superordinate communication network have been established within the scope of the PPPoE (PPP-over-Ethernet) access protocol. With PPPOE, DHCP replies are conveyed only within the scope of point-to-point connections and not within the scope of broadcast transmission methods.

Conveying of the broadcast DHCP replies can alternatively also be avoided by implementing DHCP relays in the individual multiplexer devices according to RFC 3046. DHCP relays of said type communicate directly with the individual DHCP servers and have a database containing the respectively required user information. However, DHCP relay configuring requires substantial technical effort and is very expensive, which is deemed undesirable by many network carriers.

The object of the invention is thus to further improve the establishing of communication relationships in user access networks, in particular the assigning of IP addresses within the scope of the DHCP protocol, in particular avoiding the PPPoE protocol employed hitherto. Said object is achieved proceeding from the features of the preamble of claim 1 by means of its characterizing features.

With the inventive method for establishing a communication relationship in at least one communication network at least one message initiating an establishment of the communication relationship is sent by a communication device into the communication network and at least one corresponding acknowledgment is conveyed with the aid of a broadcast transmission method via the communication network in the direction of the initiating communication device. The main feature of the inventive method is that the information representing the communication device that initiates the communication relationship is stored in the communication network and that the acknowledgment conveyed with the aid of the broadcast transmission method is detected and target information contained in the detected acknowledgment is compared with the information stored. If the information compared is found to at least partially tally, then the acknowledgment will be forwarded to the initiating communication device represented by the tallying information.

The main advantage of the inventive method is that the inflexible PPPoE access protocol can be dispensed with for establishing communication relationships, which is to say for assigning IP addresses, and the more flexible DHCP protocol employed instead. Any occurrences of multiplexer-device (DSLAM) overloading within the scope of the DHCP protocol are advantageously avoided by selectively and intelligently converting broadcast information into unicast data traffic. Internet protocols such as, for example, DHCP and ARP (Address Resolution Protocol) can as a result be made available for adequate use by network carriers and with no configuring costs.

Further advantageous embodiments of the inventive method as well as a communication arrangement and a communication device for a communication arrangement for establishing a communication relationship are disclosed in the further claims.

The inventive method is explained in more detail below with the aid of several drawings:

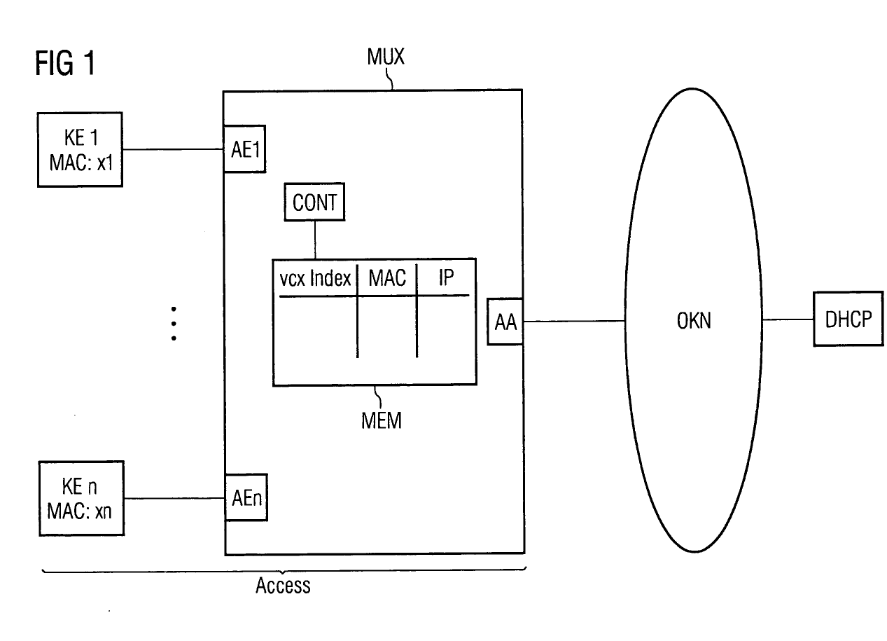

FIG. 1 shows in block-diagram form a connection scenario, arranged in a user-line network, for implementing the inventive method,

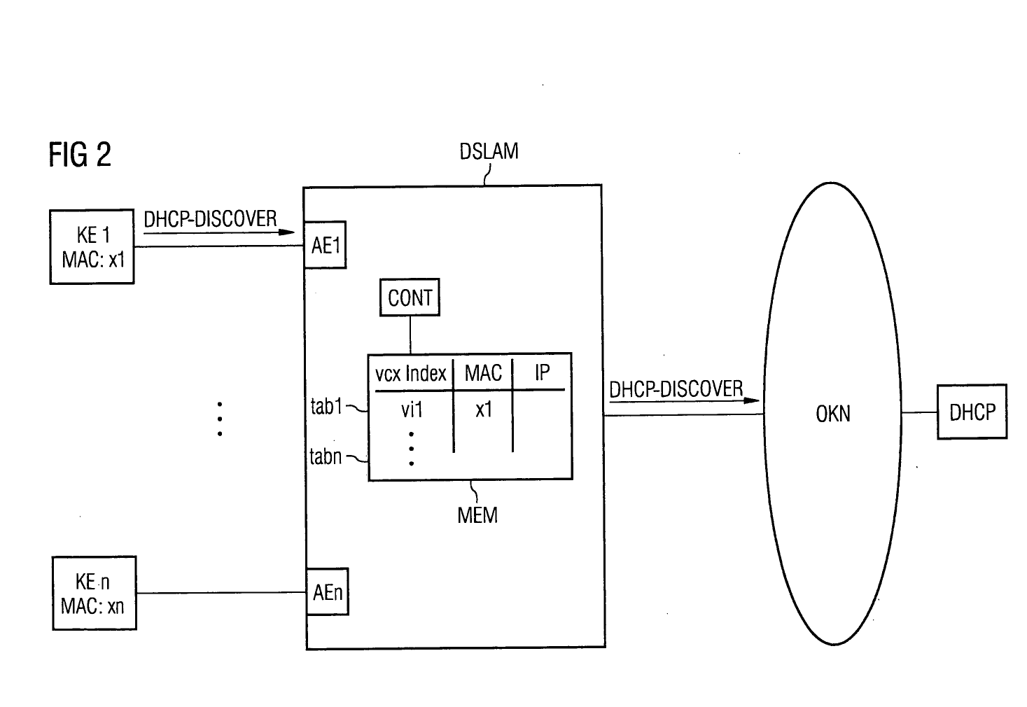

FIGS. 2 to 5 show the chronological sequence of DHCP messages conveyed within the scope of the inventive method.

FIG. 1 shows in block-diagram form a plurality of users or communication devices KE1 . . . n allocated thereto that are arranged in a user access network or, simply, access network ACCESS and are connected via respective trunk lines to corresponding line units AE1 . . . n of a multiplexer device MUX—referred to also as DSLAM (Digital Subscriber Line Access Multiplexer). The multiplexer device MUX is connected via a further connecting device AA or uplink to a superordinate communication network OKN embodied according to the Internet Protocol. Located in the superordinate communication network OKN is a DHCP (Dynamic Host Configuration Protocol) server. Located in the multiplexer device MUX is a control device CONT that controls the inventive method's implementation and to which are assigned storage means MEM.

It is assumed in the explanations that follow that a communication relationship or a network relationship embodied according to the Internet Protocol is to be established between the first communication device KE1 and superordinate communication network OKN, with the first communication device requiring to be assigned a corresponding IP address by the DHCP server for establishing the network connection.

According to FIG. 2 a “DHCP-DISCOVER message” is within the scope of the DHCP protocol (RFC 2131) conveyed by means of broadcast transmission methods or broadcasting into the superordinate communication network OKN by the first communication device—referred to also as a client—, through which action a DHCP server that is ready to reply is to be discovered. According to FIG. 2 the DHCP-DISCOVER message sent by the first communication device KE1 is first conveyed to the multiplexer device MUX, by which the message is to be forwarded by means of broadcasting to the superordinate communication network OKN. The control device CONT located in the multiplexer device MUX is inventively embodied in such a way that the MAC address—in this case mac=x1—of the communication device KE1 sending the DHCP-DISCOVER message will be stored in a data field tab1 . . . n of the memory MEM allocated to the control device CONT along with information (referred to also as the cross-connect index “vcxIndex”)—in this case vcxIndex=vi1—representing the respective cross-connect point of the communication device KE1.

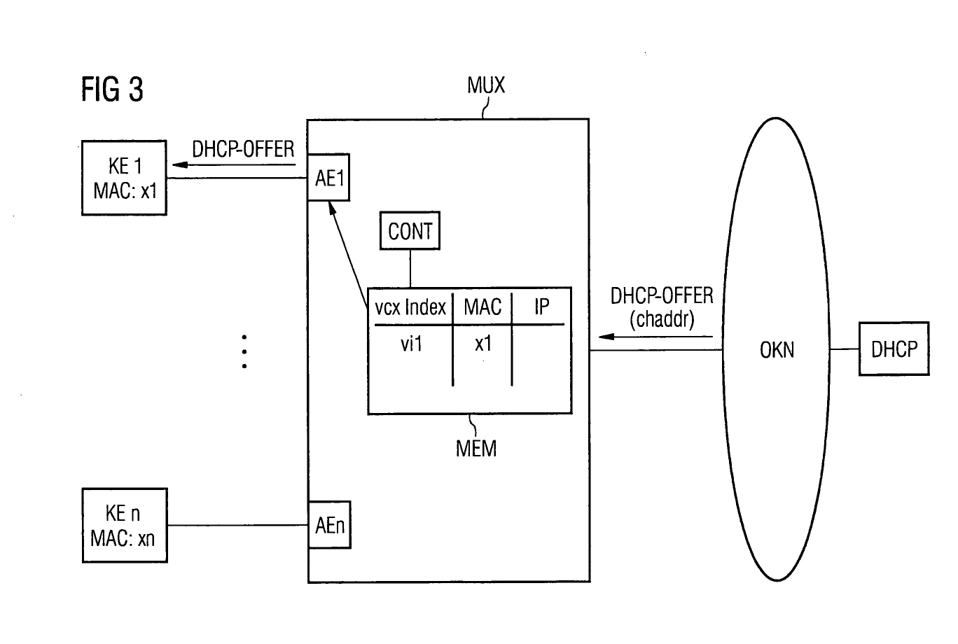

A corresponding acknowledgment—in this case DHCP-OFFER—is conveyed as a reply by the DHCP server located in the superordinate communication network OKN by means of broadcasting via the superordinate communication network OKN in the direction of the requesting communication device KE1—see FIG. 3. DHCP-OFFER messages received at the multiplexer device MUX are checked by the control device CONT. If the DHCP-OFFER message was sent by the DHCP server in unicast form, then the target address or MAC address contained in the DHCP-OFFER message will be compared within the scope of the customary switching method with database entries and, where applicable, forwarded directly to the respective communication device KE1 . . . n.

If the DHCP-OFFER message was sent by the DHCP server within the scope of a broadcast directed at all users KE1 . . . n, then the user's sending address (in this case the target address, chaddr, conveyed within the scope of the DHCP protocol) contained in the DHCP-OFFER message will inventively be compared by the control device CONT with the user addresses MAC stored in the memory MEM, with, if a degree of tallying is established, the DHCP-OFFER message being forwarded to the associated cross-connect index (in this case vcxIndex=vi1) likewise stored in the memory MEM. The DHCP-OFFER message is inventively forwarded by the multiplexer device MUX as a unicast only to the user—in this case KE1—stored in the memory MEM so that inundating or overloading of the multiplexer device MUX with broadcast messages will be prevented.

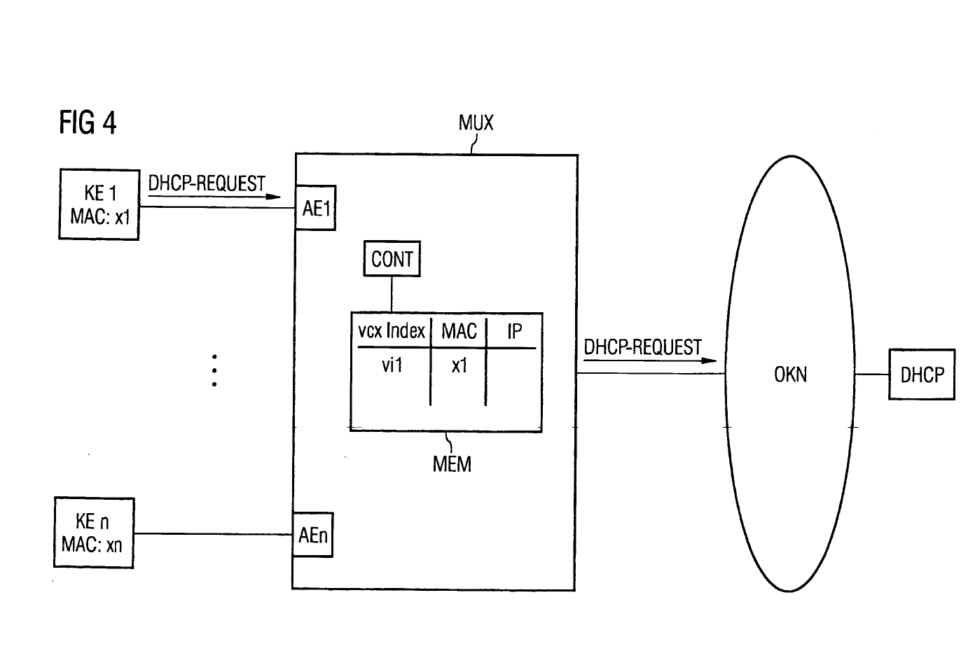

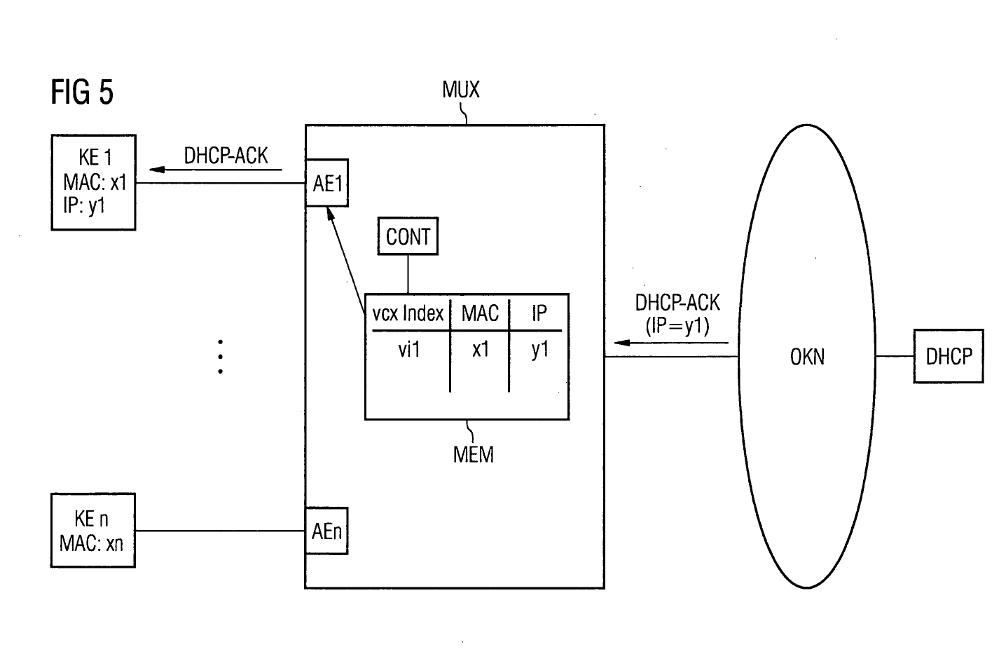

When the DHCP-OFFER message has been received a check can be performed by the communication device KE1 to determine whether an IP address is to be requested from said DHCP server. A DHCP-REQUEST message will then, if required, be sent to said DHCP server—see FIG. 4. Said DHCP-REQUEST message will be detected by the control device CONT located in the multiplexer device MUX and, within the scope of the inventive method, corresponding information—in this case the broadcast flag in the DHCP data field—set in the message. What is achieved thereby is that all the DHCP server's replies will likewise be returned in broadcast form. What is in turn achieved in this way is that the DHCP server's replies will be conveyed to the respective requesting users KE1 . . . n not directly but, within the scope of broadcasting, back along the path via the multiplexer device MUX. It is thus insured that the DHCP-ACK messages sent by the DHCP server will be registered by the control device CONT and evaluated and the IP addresses IP that are contained in the DHCP-ACK messages or have been assigned will be stored in the memory MEM before the DHCP-ACK message is forwarded with the assigned IP address—in this case IP=y1—to the corresponding communication device KE1—see FIG. 5. The DHCP-ACK message is evaluated in the same manner as the previously received DHCP-OFFER messages: Registering the user's sending address (chaddr) contained in the message, then comparing it with the user addresses MAC stored in the memory MEM, and forwarding the DHCP-ACK message to the relevantly associated cross-connect index (vcxIndex) if a degree of tallying has been established.

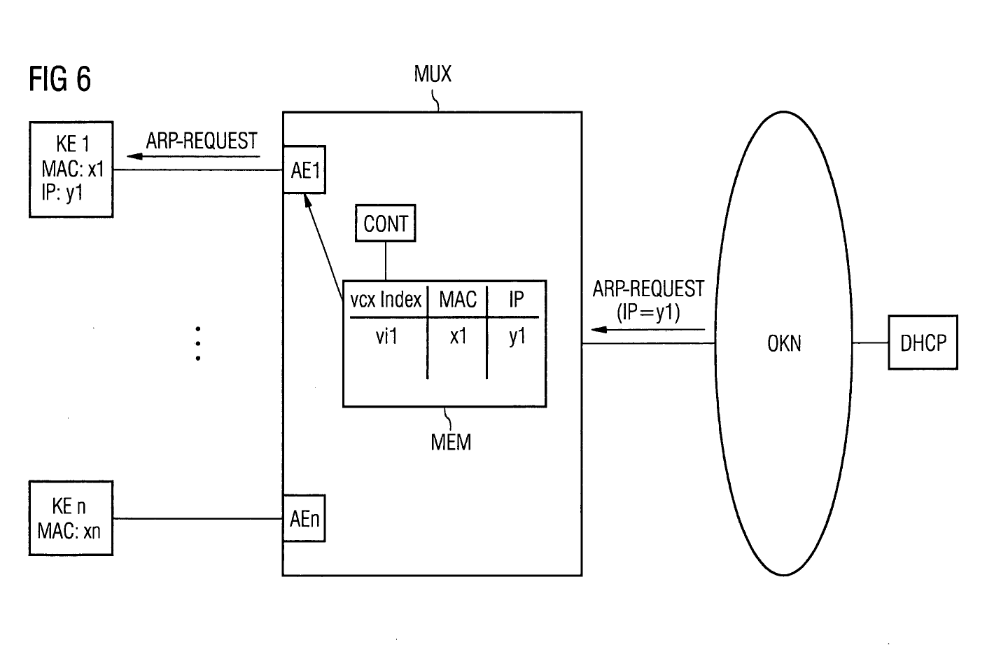

On completion of the DHCP protocol, which is to say when an IP address IP has been allocated to the respective communication device KE1, said device can basically be identified and addressed by all communication devices located in the at least one communication network OKN, which is to say it will be possible to establish communication relationships to and from the communication device KE1 . . . n. If information is to be conveyed to, for example, the first communication device KE1 from a communication device—not shown—located in the superordinate communication network OKN, then not only the IP address—in this case IP=y1—of the communication device—in this case KE1—requiring to be addressed will be needed to convey information but also its hardware or MAC address—in this case MAC=x1. That can be obtained by sending an ARP (Address Resolution Protocol) request with the specified IP address as a broadcast to all accessible users—see FIG. 6. Said request will usually be answered by the communication device addressed by the IP address and the MAC address inserted into the reply. As already explained, requests or messages sent within the scope of a broadcast will be rejected by the multiplexer devices MUX to prevent overloading, meaning that ARP requests will not be forwarded by the multiplexer devices MUX and so not answered. According to an advantageous development of the inventive method, ARP requests arriving at a multiplexer device MUX will be registered by the control device CONT and the IP addresses contained or specified in the ARP requests will be compared with the IP addresses IP of the individual users or communication devices KE1 . . . n, which addresses were read out previously within the scope of the inventive method from the DHCP-ACK messages and stored in the memory MEM. If a degree of tallying is established between the IP address specified in an ARP-REQUEST message and an IP address stored in the memory MEM, then the ARP request will be forwarded to the corresponding cross-connect index (vcxIndex) of the respective communication device—in this case KE1 having the index vcxIndex=vi1. The network computer's ARP-REQUEST message can then be answered by the communication device KE1 connected at this cross-connect point, meaning that a corresponding ARP-RESPONSE message can be sent with the MAC address, inserted therein, of the first communication device KE1.

1-14. (canceled)

15. A method for establishing a communication relationship in a communication network, comprising:
sending a message by a communication device into the communication network for initiating the communication relationship;
conveying an acknowledgment via the communication network in a direction of the communication device;
storing an information representing the communication device in the communication network;
detecting the acknowledgment;
comparing a target information contained in the detected acknowledgment with the stored information; and
forwarding the acknowledgment to the communication device represented by a tallying information if the comparison at least partially tallies.

16. The method as claimed in claim 15, wherein the information stored is a MAC address or information representing a cross-connect point of the communication device.

17. The method as claimed in claim 15, wherein the communication network is packet-oriented or cell-oriented.

18. The method as claimed in claim 17, wherein the communication network is arranged according to Internet Protocol and an IP address is requested by the message sent by the communication device and inserted in the acknowledgment.

19. The method as claimed in claim 18, wherein the communication relationship is established within a scope of a DHCP protocol.

20. The method as claimed in claim 19, wherein the IP address is assigned to the communication device within the scope of the DHCP protocol and stored in the communication network.

21. The method as claimed in claim 20, wherein:
an ARP message sent by a broadcast transmission method within a scope of Address Resolution Protocol is detected,
an IP address contained in the ARP message is compared with the IP address stored in the communication network, and
the ARP message is forwarded to the communication device represented by a tallying IP address if the comparison at least partially tallies.

22. A communication arrangement for establishing a communication relationship in a communication network, comprising:
a communication device that sends a message to the communication network for initiating the communication relationship;
a device that conveys an acknowledgment via the communication network in a direction of the communication device;
a storage unit that stores an information representing the communication device; and
a comparison unit that:
detects the acknowledgment,
compares a target information contained in the detected acknowledgment with the stored information, and
forwards the acknowledgment to the communication device represented by a tallying information if the comparison at least partially tallies.

23. The communication arrangement as claimed in claim 22, wherein the information stored is a MAC address or information representing a cross-connect point of the communication device.

24. The communication arrangement as claimed in claim 23, wherein the communication network is packet-oriented or cell-oriented.

25. The communication arrangement as claimed in claim 24, wherein the communication network is arranged according to Internet Protocol and an IP address is requested by the message sent by the communication device and inserted in the acknowledgment.

26. The communication arrangement as claimed in claim 25, wherein the communication relationship is established within a scope of DHCP protocol.

27. The communication arrangement as claimed in claim 26, wherein the IP address is assigned to the communication device within the scope of the DHCP protocol and stored in the communication network.

28. The communication arrangement as claimed in claim 27, wherein:
an ARP message sent by the broadcast transmission method within a scope of Address Resolution Protocol is detected,
an IP address contained in the ARP message is compared with the IP address stored in the communication network, and
the ARP message is forwarded to the communication device represented by a tallying IP address if the comparison at least partially tallies.

29. A communication device for establishing a communication relationship in a communication network, comprising:
a transmitting unit that sends a message to the communication network for initiating the communication relationship;
a device that conveys an acknowledgment via the communication network in a direction of the communication device;
a storage unit that stores an information representing the communication device; and
a comparison unit that:
detects the acknowledgment,
compares a target information contained in the detected acknowledgment with the stored information, and
forwards the acknowledgment to the communication device represented by a tallying information if the comparison at least partially tallies.
